(19) United States
(12) Patent Application Publication
(10) Pub. No.: US 2016/0123632 A1
(43) Pub. Date: May 5, 2016

(54) ABSORPTION REFRIGERATION CYCLES USING A LGWP REFRIGERANT

(71) Applicant: HONEYWELL INTERNATIONAL INC., MORRIS PLAINS, NJ (US)

(72) Inventors: Samuel F. Yana Motta, East Amherst, NY (US); Mark W. Spatz, East Amherst, NY (US); Ryan J. Hulse, Getzville, NY (US); Rajiv Ratna Singh, Getzville, NY (US)

(21) Appl. No.: 14/991,520

(22) Filed: Jan. 8, 2016

Related U.S. Application Data
(63) Continuation-in-part of application No. 12/432,466, filed on Apr. 29, 2009.
(60) Provisional application No. 62/101,718, filed on Jan. 9, 2015.
(60) Provisional application No. 61/049,069, filed on Apr. 30, 2008.

(51) Int. Cl. F25B 15/02; C09K 5/04

(52) U.S. Cl. CPC F25B 15/025; C09K 5/047

(57) ABSTRACT

Absorptive refrigeration methods and systems that comprise refrigerant comprising one or more hydrofluoroolefin and/or hydrochlorofluoroolefins, and a solvent or absorbent selected from the group consisting of a polyalkyene glycol oil, a poly alpha olefin oil, a mineral oil and/or a polyolester oil.

### CROSS REFERENCE TO RELATED APPLICATION

This application claims the priority benefit of U.S. Provisional Application No. 62/101,718, filed Jan. 9, 2015. This application is also a continuation-in-part of U.S. application Ser. No. 12/432,466, filed Apr. 29, 2009, which claims priority to U.S. provisional Application No. 61/049,069, filed Apr. 30, 2008. Each of the applications identified in this paragraph are incorporated herein by reference.

### FIELD OF INVENTION

This invention relates to absorption refrigeration systems that employ refrigerants with low global warming potential (GWP) and low ozone depletion potential (ODP).

### BACKGROUND OF THE INVENTION

Absorption refrigeration is a more economical alternative to compression refrigeration when a source of waste or other low-cost heat (e.g. solar heating) is available. Both absorption refrigerators and vapor compression refrigerators use a refrigerant with a very low boiling point. In both types, when this refrigerant evaporates or boils, it takes some heat away with it, providing the cooling effect. However, absorption refrigeration and vapor compression refrigeration differ in the way the refrigerant is changed from a gas back into a liquid so that the cycle can repeat. A vapor compression refrigerator uses an electrically-powered compressor to increase the pressure on the gas, and then condenses the hot high pressure gas back to a liquid by heat exchange with a coolant (usually air). An absorption refrigerator changes the gas back into a liquid using a different method that needs only a low-power pump, or optionally only heat thereby eliminating the need for moving parts.

An important aspect of most absorption refrigeration cycle is the refrigerant/absorbent pair which enables the entire system. An absorbent is used to absorb the refrigerant at a condition where the absorbent is a liquid and the refrigerant would typically be a gas. The refrigerant/absorbent mixture can then be pumped as a liquid to a higher pressure, thus avoiding the need to use of a compressor. The high pressure liquid mixture is then separated at high pressure and temperature yielding a high pressure vapor refrigerant, which is fed to the condenser, and the absorbent in liquid form, which is recycled back to pick up more refrigerant.

Two of the most common absorption refrigeration pairs are NH₃-water and water-LiBr. NH₃-water uses NH₃ as the refrigerant and water as the absorbent. NH₃ performs well as a refrigerant in many applications. However, the toxicity of NH₃ restricts its use in public occupied spaces. In addition, ammonia is highly corrosive and incompatible with copper, a common material in cooling systems.

Water-LiBr is the other commonly used refrigerant pair in absorption systems. Water has two drawbacks: water freezes below 0° C., and due to low vapor density, large equipment sizing is required, making the solution impractical in space constrained locations.

Another problem with such conventional systems is that the evaporator and the absorber are typically operated below atmospheric pressure which increases the cost of such systems because the equipment must be specially designed to work safely at low pressures.

Accordingly, there remains a need for safer and environmentally friendly refrigerant for absorption-type refrigeration systems.

### SUMMARY

In certain non-limiting embodiments, the present invention relates to the discovery of refrigerant and absorbent pairs for use in absorption refrigeration systems. Certain hydrofluoroolefins and/or hydrochlorofluoroolefins, particularly those suitable for use as refrigerants, are at least partially soluble in an oil such as polyalkyene glycol oil, poly alpha olefin oil, mineral oil, and polyol ester oil. It has been discovered that certain pairings of refrigerants and oils enable exceptional performance of absorption refrigeration systems, including but not limited to such systems in which the heat source comprises a solar collector. Many of these refrigerants are characterized as having a low-GWP (i.e., <1000, and preferably <100 relative to CO₂), a low or no appreciable ozone depletion potential, and are non-toxic and non-flammable.

Accordingly, an aspect of this invention involves a method for providing refrigeration comprising: (a) evaporating a first liquid-phase refrigerant stream comprising a refrigerant selected from the group consisting of one or more hydrofluoroolefins, one or more hydrochlorofluoroolefins, and blends thereof, to produce a low-pressure vapor-phase refrigerant stream, wherein said evaporating transfers heat from a system to be cooled; (b) contacting said low-pressure vapor-phase refrigerant stream with a first liquid-phase solvent stream comprising a solvent selected from the group consisting of a polyalkyene glycol oil, a poly alpha olefin oil, a mineral oil, a polyolester oil, and combinations thereof under conditions effective to dissolve substantially all of the refrigerant of the vapor-phase refrigerant stream into the solvent of the first liquid-phase solvent stream to produce a refrigerant-solvent solution stream; (c) increasing the pressure and temperature of the refrigerant-solvent solution stream by transfer of heat from a solar collector to said solution; (d) thermodynamically separating said refrigerant-solvent solution stream into a high-pressure vapor-phase refrigerant stream and a second liquid-phase solvent stream; (e) recycling said second liquid-phase solvent stream to step (b) to produce said first liquid-phase solvent stream; (f) condensing said high-pressure vapor-phase refrigerant stream to produce a second liquid phase refrigerant stream; and (g) recycling said second liquid-phase refrigerant stream to step (a) to produce said first liquid-phase refrigerant stream.

In certain embodiments of the invention, the absorption process is characterized as a double or triple effect. Accordingly, in another aspect of the invention provided is an absorption refrigeration system comprising: (a) a refrigerant selected from the group consisting of one or more hydrofluoroolefins, one or more hydrochlorofluoroolefins, and blends thereof; (b) a solvent selected from the group consisting of a polyalkyene glycol oil, a poly alpha olefin oil, a mineral oil, a polyolester oil, and combinations thereof; (c) an evaporator suitable for evaporating said refrigerant; (d) a condenser suitable for condensing said refrigerant; (e) a separator suitable for thermodynamically separating a solution comprising said refrigerant dissolved in said solvent into a vapor refrigerant component and a liquid solvent component; and (f) at least one gas-dissolving subsystem comprising a mixer suitable for mixing said refrigerant with said solvent, an absorber suitable for dissolving at least a portion of said refrigerant into said solvent to produce a solution, a pump, and a heat exchanger, wherein said mixer is fluidly connected to said absorber, said absorber is fluidly connected to said pump, and said pump is fluidly connected to said heat exchanger; wherein said gas-dissolving subsystem is in fluid communication with said at least two units selected from the group consisting of said evaporator, said separator, and another gas-dissolving subsystem, provided that at least one subsystem is in fluid communication with said evaporator and at least one subsystem is in fluid communication with said separator.

As used herein, the terms “low-pressure vapor-phase refrigerant” and “high-pressure vapor-phase refrigerant” are relative to one another. That is, a low-pressure vapor-phase refrigerant has a pressure above 0 psia, but lower than the pressure of the high-pressure vapor-phase refrigerant. Likewise, the high-pressure vapor-phase refrigerant has a pressure below the composition's critical point, but higher than the pressure of the low-pressure vapor-phase refrigerant.

As used herein, the term “substantially all” with respect to a composition means at least about 90 weight percent based upon the total weight of the composition.

In another aspect, the invention provides an absorption refrigeration system comprising: (a) a refrigerant selected from the group consisting of one or more hydrofluoroolefins, one or more hydrochlorofluoroolefins, and blends thereof; (b) a solvent selected from the group consisting of a polyalkyene glycol oil, a poly alpha olefin oil, a mineral oil, a polyolester oil, and combinations thereof; (c) an evaporator suitable for evaporating said refrigerant; (d) a mixer suitable for mixing said refrigerant with said solvent, wherein said mixer is fluidly connected to said evaporator; (e) an absorber suitable for dissolving at least a portion of said refrigerant into said solvent to produce a solution, wherein said absorber is fluidly connect to said mixer; (f) a pump fluidly connected to said absorber; (g) a heat exchanger fluidly connected to said pump, wherein the heat exchanger in certain embodiments absorbs heat from a solar collector; (h) a separator suitable for thermodynamically separating said solution into a vapor refrigerant component and a liquid solvent component, wherein said separator is fluidly connected to said heat exchanger; (i) an oil return line fluidly connected to said separator and said mixer, and (j) a condenser suitable for condensing said vapor refrigerant component, wherein said condenser is fluidly connected to said separator and said evaporator.

In preferred aspects the invention provides environmentally friendly, economical refrigeration processes. Additional embodiments and advantages will be readily apparent to the skilled artisan on the basis of the disclosure provided herein.

### BRIEF DESCRIPTION OF THE DRAWINGS

FIG. 1 is a graph of the solubility of trans-1,3,3,3-tertafluoropropene (1234ze(E)) in PAG refrigerant compressor oil as determined according to Example 2.

FIG. 2 is a graph of the solubility of trans-1,3,3,3-tetrafluoropropene (1234ze(E)) in POE oil as determined according to Example 5.

FIG. 3 is a graph of the solubility of trans-1-chloro-3,3,3-trifluoropropene (1233zd(E)) in mineral oil as determined according to Example 8.

FIG. 4 is a simplified schematic of a single effect absorption refrigeration cycle.

FIG. 5 is a simplified schematic of a double effect absorption refrigeration cycle.

### DETAILED DESCRIPTION

In certain non-limiting embodiments, the present invention relates to the discovery of refrigerant and absorbent pairs for use in connection with low-grade heat sources, and in particular low grade heat sources such as waste-heat sources, solar-derived heat source, geothermal derived heat sources and combinations of these. Residential and commercial buildings are large consumers of electric energy with fluctuating demand. Electricity is produced by the most efficient equipment running nearly continuously. However to meet peak demand, less efficient equipment is used, usually fueled by natural gas or oil. Natural gas prices are volatile, and dependence on oil dilutes U.S. security. However, peak demand places additional burden on the electrical grid. The reliability of electrical service is improved when peak demand is flattened. US economic security is enhanced when brown-outs or power interruptions are reduced or eliminated while transferring peak demands to low-grade, and preferably renewable US resources (solar or geothermal) or waste heat sources.

As demonstrated herein, combinations of the refrigerants and absorbents provided herein, when used in such low-grade heat, and preferably renewable sources such as solar-derived and/or geothermal-derived heat, can significantly reduce annual electricity consumption by approximately 10% for the US average and 30% for hot climates. It can further result in a reduction of CO₂ emissions of up to 11% for the US average and 30% for hot climates. In hot climates, in particular, the present absorption system provides peak cooling at times of peak demand. In other applications, such as heat pumps, similar improvements are observed.

According to ceratain preferred embodiments in which the heat source includes a solar collector preferably comprises concentrated and/or non-concentrated solar collection systems. Concentrated solar thermal collectors typically use mirrors and reflection, or the like, to concentrate energy from the sun from a cross section much larger than the absorber cross section. It is able to generate high fluid temperatures (up to 400° C., and in some cases, even higher) using such systems. These arrays also require mechanisms to maintain optimal alignment with the sun and regular monitoring and preventive maintenance to maintain the desired output.

A non-concentrated array is typically a self-cleaning, stationary structure that absorbs only the sunlight that directly impinges the thermal absorbing coating. Non-concentrated solar absorbers are typically capable of producing temperatures up to about 140° C. for evacuated tube designs and generally up to about 90° C. for advanced flat plate designs.

The present invention may include either of these designs or a combination of both. In certain non-limiting embodiments, it includes evacuated tube specifications to produce a solar air conditioning system reaching a maximum temperature of 120° C.

Regardless of the type of array used, the heat collected from the solar collector operates as a “thermal compressor” to the refrigeration system. That is, it facilitates heating the refrigerant and absorbent such that the two may be separable under high temperature/high pressure conditions. The advantages of absorption systems are simplicity, reliability and long term durability due to very few mechanical parts. The only moving piece of an absorption system is a liquid pump. Absorption systems have the disadvantages of limited working fluids. Until now, absorption refrigeration has been limited to industrial applications because safe refrigerant/absorbent fluid pairs were not available.

In preferred embodiments of the invention, a hydrofluoroolefin and/or hydrochlorofluoroolefin refrigerant is used in the absorption-type refrigeration system as a working fluid, i.e., a fluid that changes states from gas to liquid or vice versa via a thermodynamic cycle. This phase change is facilitated by dissolving the vapor-phase refrigerant in an oil solvent to form a solution. Preferably, a pump and heat exchanger are used to efficiently increase the solution's pressure and temperature, respectively. The pressurized and heated solution is then flashed to produce a refrigerant vapor at high pressure. This high pressure vapor is then passed through a condenser and evaporator to transfer heat from a system to be cooled.

Preferred, but non-limiting, refrigerants for this invention include hydrofluoroolefins and hydrochlorofluoroolefins of the formula C_{w}HₓF_{y}Cl_{z} where w is an integer from 3 to 5, x is an integer from 1 to 3, and z is an integer from 0 to 1, and where y=(2·w)−x−z. Particularly preferred refrigerants include hydrohalopropenes, more preferably tetrahalopropenes, even more preferably tetrafluoropropenes and mono-chloro-trifluoropropenes, even more preferably tetrahalopropenes having a —CF₃ moiety. In certain preferred embodiments, the refrigerant including one or a combination of 2,3,3,3-tetrafluoropropene, 1,3,3,3-tetrafluoropropene, or 1-chloro-3,3,3-trifluoropropene, including all stereoisomers thereof, such as trans-1,3,3,3-tertafluoropropene, cis-1,3,3,3-tertafluoropropene, trans-1-chloro-3,3,3-trifluoropropene, cis-1-chloro-3,3,3-trifluoropropene and 3,3,3-trifluoropropene. Certain useful refrigerants also comprise a mixture of two or more hydrofluoroolefins, hydrochlorofluoroolefins, as well as mixtures of both hydrofluoroolefins and hydrochlorofluoroolefins.

Solvents or absorbents useful in the present invention preferably are selected from the group consisting of polyalkyene glycol oil, a poly alpha olefin oil, a mineral oil and a polyol ester oil. The oils selected are generally thermally stable, have very low vapor pressures, and are non-toxic and non-corrosive. Preferred oils that fit these criteria and can be used with various olefins above are poly-ethylene glycol oils, polyol ester oils, polypropylene glycol dimethyl ether-based and mineral oil.

In preferred non-limiting embodiments, the refrigerant is or includes 2,3,3,3-tetrafluoropropene (HFO-1234yf) and the solvent (or absorbent) is selected from polyalkyene glycol oil, a poly alpha olefin oil, a mineral oil and a polyol ester oil. In further embodiments, the refrigerant is or includes 2,3,3,3-tetrafluoropropene (HFO-1234yf) and the solvent (or absorbent) is selected from a polyalkyene glycol oil and/or a polyol ester oil.

In preferred non-limiting embodiments, the refrigerant comprises at least about 50% by weight, more preferably at least about 75% by weight and even more preferably in non-limiting embodiments comprises about 100% of 2,3,3,3-tetrafluoropropene (HFO-1234yf) and the solvent (or absorbent) is comprises at least about 50% by weight, more preferably at least about 75% by weight and even more preferably in non-limiting embodiments comprises about 100% of selected from polyalkyene glycol oil, a poly alpha olefin oil, a mineral oil and a polyol ester oil. In further embodiments, the refrigerant is or includes 2,3,3,3-tetrafluoropropene (HFO-1234yf) and the solvent (or absorbent) is selected from a polyalkyene glycol oil and/or a polyol ester oil.

In preferred non-limiting embodiments, the refrigerant comprises at least about 50% by weight, more preferably at least about 75% by weight and even more preferably in non-limiting embodiments comprises about 100% of 2,3,3,3-tetrafluoropropene (HFO-1234yf) and the solvent (or absorbent) comprises at least about 50% by weight, more preferably at least about 75% by weight and even more preferably in non-limiting embodiments comprises about 100% of polyalkyene glycol oil.

In preferred non-limiting embodiments, the refrigerant comprises at least about 50% by weight, more preferably at least about 75% by weight and even more preferably in non-limiting embodiments comprises about 100% of 2,3,3,3-tetrafluoropropene (HFO-1234yf) and the solvent (or absorbent) comprises at least about 50% by weight, more preferably at least about 75% by weight and even more preferably in non-limiting embodiments comprises about 100% of polyol ester oil.

In certain non-limiting embodiments, the refrigerant is or includes 1,3,3,3-tetrafluoropropene (HFO-1234ze) and the solvent (or absorbent) is selected from polyalkyene glycol oil, a poly alpha olefin oil, a mineral oil and a polyol ester oil. In further embodiments, the refrigerant is or includes 1,3,3,3-tetrafluoropropene (HFO-1234ze) and the solvent (or absorbent) is selected from a polyalkyene glycol oil and/or a polyol ester oil. In certain aspects of the foregoing, 1,3,3,3-tetrafluoropropene comprises, consists essentially of, or consists of the trans isomer.

In preferred non-limiting embodiments, the refrigerant comprises at least about 50% by weight, more preferably at least about 75% by weight and even more preferably in non-limiting embodiments comprises about 100% of trans1,3,3,3-tetrafluoropropene (HFO-1234ze(E)) and the solvent (or absorbent) comprises at least about 50% by weight, more preferably at least about 75% by weight and even more preferably in non-limiting embodiments comprises about 100% of polyol ester oil.

In preferred non-limiting embodiments, the refrigerant comprises at least about 50% by weight, more preferably at least about 75% by weight and even more preferably in non-limiting embodiments comprises about 100% of trans1,3,3,3-tetrafluoropropene (HFO-1234ze(E)) and the solvent (or absorbent) comprises at least about 50% by weight, more preferably at least about 75% by weight and even more preferably in non-limiting embodiments comprises about 100% of polyalkyene glycol oil.

In certain non-limiting embodiments, the refrigerant is or includes 1-chloro-3,3,3-trifluoropropene (HCFO-1233zd) and the solvent (or absorbent) is selected from polyalkyene glycol oil, a poly alpha olefin oil, a mineral oil and a polyol ester oil. In further embodiments, the refrigerant is or includes 1-chloro-3,3,3-trifluoropropene (HCFO-1233zd) and the solvent (or absorbent) is selected from a polyalkyene glycol oil, a polyol ester oil, and/or a mineral oil. In certain aspects of the foregoing, 1-chloro-3,3,3-trifluoropropene (HCFO-1233zd) comprises, consists essentially of, or consists of the trans isomer.

In preferred non-limiting embodiments, the refrigerant comprises at least about 50% by weight, more preferably at least about 75% by weight and even more preferably in non-limiting embodiments comprises about 100% of trans1-chloro-3,3,3-trifluoropropene (HCFO-1233zd(E)) and the solvent (or absorbent) comprises at least about 50% by weight, more preferably at least about 75% by weight and even more preferably in non-limiting embodiments comprises about 100% of polyol ester oil.

In preferred non-limiting embodiments, the refrigerant comprises at least about 50% by weight, more preferably at least about 75% by weight and even more preferably in non-limiting embodiments comprises about 100% of trans1-chloro-3,3,3-trifluoropropene (HCFO-1233zd(E)) and the solvent (or absorbent) comprises at least about 50% by weight, more preferably at least about 75% by weight and even more preferably in non-limiting embodiments comprises about 100% of polyalkylene glycol oil.

In preferred non-limiting embodiments, the refrigerant comprises at least about 50% by weight, more preferably at least about 75% by weight and even more preferably in non-limiting embodiments comprises about 100% of trans1-chloro-3,3,3-trifluoropropene (HCFO-1233zd(E)) and the solvent (or absorbent) comprises at least about 50% by weight, more preferably at least about 75% by weight and even more preferably in non-limiting embodiments comprises about 100% of mineral oil.

In preferred non-limiting embodiments, the refrigerant comprises at least about 50% by weight, more preferably at least about 75% by weight and even more preferably in non-limiting embodiments comprises about 100% of trans1-chloro-3,3,3-trifluoropropene (HCFO-1233zd(E)) and the solvent (or absorbent) comprises at least about 50% by weight, more preferably at least about 75% by weight and even more preferably in non-limiting embodiments comprises about 100% of alkylbenzene oil.

In preferred non-limiting embodiments, the refrigerant comprises at least about 50% by weight, more preferably at least about 75% by weight and even more preferably in non-limiting embodiments comprises about 100% of trans1-chloro-3,3,3-trifluoropropene (HCFO-1233zd(E)) and the solvent (or absorbent) comprises at least about 50% by weight, more preferably at least about 75% by weight and even more preferably in non-limiting embodiments comprises about 100% of silicone oil.

Preferably, the refrigerant and solvent are mixed in proportions and under conditions effective to form a solution in which the refrigerant is dissolved in the solvent. Preferably the mixture of refrigerant and solvent is in proportions in which a substantial portion, and more preferably substantially all, of the refrigerant mixed with the solvent is dissolved in the solvent. That is, it is preferred that the amount of refrigerant to be mixed with the solvent is below the saturation point of the solvent at the operating temperature and pressure of the refrigerant system. Maintaining the refrigerant concentration below the saturation point decreases the likelihood that vapor refrigerant will reach the pump, where it could lead to cavitations.

In certain embodiments, the refrigerant and solvent may be mixed by a mixer. Preferred mixers include static mixers and aspirators (i.e., venturi pump). In certain embodiments, the mixer is a simple junction of two transfer lines (e.g., pipes, tubes, hoses, and the like) that produces a turbulent flow, such as a T-fitting.

Dissolution of the low-pressure vapor phase refrigerant in the oil solvent preferably occurs at refrigerant temperature of about −10° C. to about 30° C., more preferably about 0° C. to about 10° C.

Preferably, the dissolution of the refrigerant in the solvent occurs, at least to a major portion, in an absorber. The absorber can be of any type that is suitable for dissolving a refrigerant gas into an oil-based solvent. Examples of absorbers include heat exchangers through or around which a cooling medium is circulated.

The solution comprising the refrigerant and solvent is pumped against a means of resistance to increase the pressure of the solution. Pumping the liquid solution to a high operating pressure typically requires significantly less energy compared to compressing a vapor refrigerant using a compressor. In addition to expending less energy, pumps are typically less costly to install and maintain compared to compressors. This energy and cost savings is a distinct advantage of the present invention over conventional compression-type refrigeration systems.

The solution is also heated, preferably after being pressurized. Heating is preferably accomplished using a heat exchanger, such as shell-and-tube heat exchangers and plate heat exchangers or a distillation column. In preferred embodiments, heating the solution involves transferring heat from a low-grade heat source, a waste-heat recovery unit (WHRU), a geothermal source, a solar-derived source and the like. A WHRU can include, for example, heat from a hot gas or liquid stream, such an exhaust gas from a gas turbine or waste gas from a power plant or refinery. The working medium for the heat source can vary depending on the particulars of individual application, but is preferably in many applications water—either pure or with triethylene glycol (TEG), thermal oil or other mediums conducive to heat transfer. In other embodiments, heating the solution involves direct heating from combustion of a fuel such a propane, with heat derived from a solar and/or geothermal source being highly preferred embodiments, as discussed herein.

After the solution is heated and pressurized, it is subjected to a thermodynamic separation process to produce a vapor refrigerant fraction and a liquid solvent fraction. Examples of such thermodynamic separation processes include column distillation and flashing. Since the two fractions are in different phases, they can be separated easily.

Preferably, the liquid solvent phase is recirculated back to the mixer, while the vapor phase comprising the refrigerant is transferred to a condenser where at least a portion, and preferably substantially all, of the refrigerant is converted from its vapor phase to a liquid phase.

The types of condenser useful in the invention are not particularly limited provided that they are suitable for condensing a hydrofluoroolefin or hydrochlorofluoroolefin refrigerant. Examples of condensers include horizontal or vertical in-shell condensers and horizontal or vertical in-tube condensers.

The liquid phase refrigerant is preferably passed through an expansion valve to lower the pressure of the refrigerant and, correspondingly, cool the refrigerant. The cooled, throttled refrigerant can be in a liquid-phase, vapor-phase, or a mixed-phase.

The refrigerant is then passed through an evaporator wherein the cooling capacity of the refrigerant during evaporation is used to extract heat (i.e., refrigerate) the system to be cooled. Preferably, the material to be cooled in the system is water, with or without a heat transfer additive such as PEG, which can be used, for example, chilled water circulated to air handlers in a distribution system for air conditioning. However, the material to be cooled can also be air used directly for air conditioning. In addition, the external material can also be any flowable material that needs to be cooled, and if water or air, the cooled materials can be used for purposes other than air conditioning (e.g., chilling food or other products).

The type of evaporator used to evaporate the liquid-phase refrigerant is not particularly limited provided that it is suitable for evaporating a hydrofluoroolefin or hydrochlorofluoroolefin refrigerant. Examples of useful evaporators include forced circulation evaporators, natural circulation evaporator, long-tube and short-tube vertical evaporators, falling film evaporators, horizontal tube evaporators, and plate evaporators.

After the refrigerant is evaporated it becomes a low-pressure vapor-phase refrigerant preferably having a temperature of about 30° C. to about 60° C., more preferably about 40° C. to about 50° C. The low-pressure vapor-phase refrigerant is preferably recirculated back to the mixer.

The processes of the present invention are preferably a closed-loop system wherein both the refrigerant and solvent are recirculated. Absorption refrigeration systems according to this invention preferably involve a single, double, or triple effect absorption refrigeration process. Single and double effect processes are described in the Examples and figures described below.

### EXAMPLES

### Example 1

A steady state system model using ideal components was developed to look at the use of low GWP refrigerant HFO-1234yf with a lubricant (e.g. a polyalkylene glycol or polyol ester) as the absorbent. The efficiency or coefficient of performance (COP) of the absorption cycle was calculated as Q_{cooling}/(Qᵢₙ+Wₚ). Even though Qᵢₙ is considered waste heat in many applications and is a “free” source of energy in the solar application, this is the best way to compare potential refrigerant pairs. The modeling first looked at a NH₃-water absorption cycle and found operation with a COP of about 0.6 at an evaporator temperature of 5° C. and an ambient temperature of 40° C. For the ideal HFO-1234yf with lubricant model, the COP was found to be about 0.6 for the same operating parameters, i.e., when operated at an evaporator temperature of 2° C. and an ambient temperature of 40° C.

Using this system model, the performance of the proposed system and relative to present technology was evaluated with bin analysis. The electricity consumed for cooling a typical large retail building using conventional roof-top air-conditioning units (RTU) over the course of a year was compared to an equivalently sized solar powered, absorption assisted RTU. This analysis considered both averaged weather data for 29 cities across the U.S. (Air Conditioning, Heating and Refrigeration Institute Standard for chillers (AHRI Std 550)) and also a hot dry climate, Phoenix, Ariz. A summary of the evaluation is provided in Table 1, below.

TABLE 1
Comparison of annual energy consumption and peak electricity
demand for a typical large store (100,000 ft²) using
conventional roof top units versus absorption assisted roof top
units (assuming 450 tons of total cooling).

| | | Absorption | Energy/ |
|---|---|---|---|
| | Standard | Assisted | Power |
| | RTU | RTU | Reduction |
| US Average Annual Energy | 1169 MWh | 1059 MWh | 9.5% |
| Consumption | | | |
| US Peak Electricity Demand | 602 kW | 517 kW | 14.1% |
| Phoenix Average Annual Energy | 1566 MWh | 1098 MWh | 29.9% |
| Consumption | | | |
| Phoenix Peak Electricity | 698 kW | 583 kW | 16.5% |
| Demand | | | |

To further explore the benefits of applying this technology, an analysis of the overall environmental impact of these cooling technologies was conducted. Since most of the energy produced in the U.S. is produced from the burning of fossil fuel (i.e. coal, natural gas, oil), the electrical energy consumed in this equipment will result in the emission of CO₂ thus contributing to global warming. In addition to this “indirect contribution” there is also the direct effect of the release of global warming gases from refrigerant leakage in RTUs. The prevalent R410A refrigerant in RTUs has a GWP in excess of 2100. Leakage of this refrigerant is 2100 times worse than the proposed refrigerant mixture. A Life Cycle Climate Performance (LCCP) analysis takes these sources into account along with the impact of the manufacturing process of the global warming gas. A summary of the LCCP analysis given in Table 2, below.

TABLE 2
LCCP comparison for a typical large store using conventional roof top units
relative to absorption assisted roof top units.

| | | US - | | AZ - |
|---|---|---|---|---|
| | US - Standard | Absorption | AZ - Standard | Absorption |
| | RTU | Assisted RTU | RTU | Assisted RTU |
| Indirect CO₂ Contribution | 11,433 tonnes | 10,382 tonnes | 15,248 tonnes | 10,673 tonnes |
| Direct CO₂ Contribution | 857 tonnes | 552 tonnes | 911 tonnes | 591 tonnes |
| Total CO₂ Contribution | 12,290 tonnes | 10,934 tonnes | 16,159 tonnes | 11,264 tonnes |
| Lifetime CO₂ Reduction | 11% | | 30% | |

This innovation involves the use of solar collectors at reasonably high temperature output, which qualifies evacuated tube solar collectors (commercially available products) to be used for this application. For absorption cooling with a cooling COP of 0.6, the required install area per ton of cooling would be approximately 18 m² for an 800 W/m² solar day or rather an array that accounts approximately ⅓^{rd} of the roof area in the above analysis. This also allows the store to avoid peak electrical demand charges by providing “free” cooling during peak demand and ultimately reduces the peak electrical grid load.

### Example 2

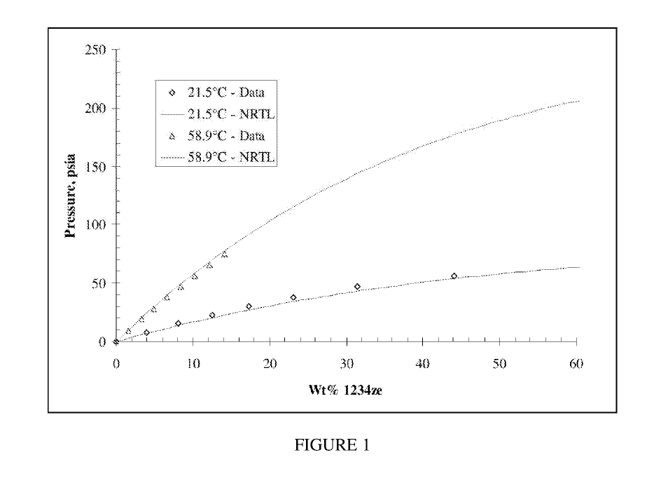

The solubility of trans-1,3,3,3-tertafluoropropene (1234ze(E)) in Ford Motor craft oil (a PAG refrigerant compressor oil meeting Ford specification No. WSH-M1C231-B) was measured by means of a micro-balance. The solubility that was measured along with the correlation of the data using the Non-Random Two Liquid (“NRTL”) activity coefficient model (Renon H., Prausnitz J. M., “Local Compositions in Thermodynamic Excess Functions for Liquid Mixtures,” AIChE J., 14(1), S.135-144, 1968)) is shown in FIG. 1. From these data it is seen that the Ford Motor Craft oil has nearly negligible vapor pressure and that the NRTL model can accurately represent the data.

### Example 3

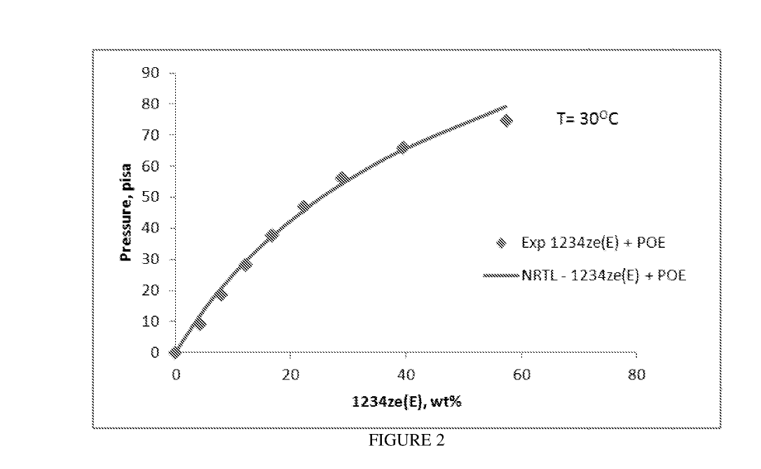

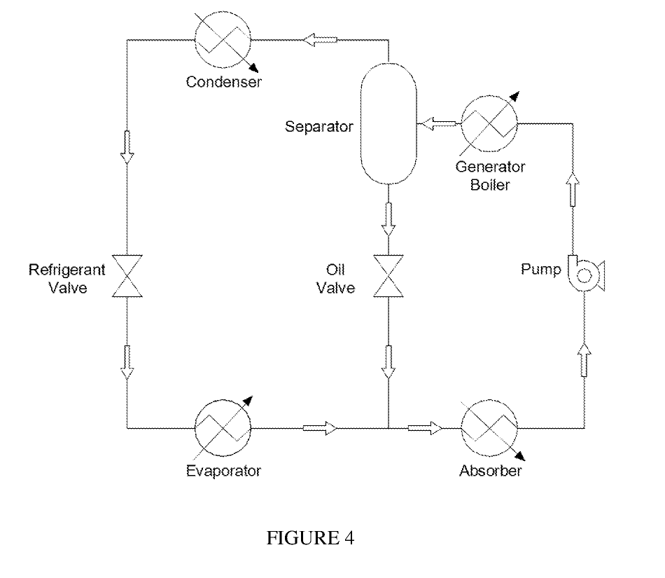

The data from Example 2 was used to develop a single effect absorption cycle. A absorption refrigeration system as disclosed in FIG. 4 is used. A Ford Motorcraft polypropylene glycol dimethyl ether-based oil is mixed with a liquid 1234ze(E) refrigerant in a closed mixer (which can be a simple “T” joint connecting two or more lines). The mixture is passed to an absorber where the gaseous 1234ze(E) dissolves to the extent indictated in FIG. 2 at the to the oil. The liquid mixture is passed to a pump that pressurizes the mixture and passes the mixture to a heat exchanger/boiler. In the boiler, heat is exchanged with the mixture. The source of that heat can be thermal heat from a solar collector external to the heat exchanger. The temperature of the mixture is raised to a temperature where the 1234ze(E) refrigerant can separate from the oil. The heated mixture is removed from the heat exchanger and introduced to a separator whereby the refrigerant separates substantially in a vapor state from the oil that remains substantially in a liquid state. The oil is then returned through an oil valve where its pressure is decreased to match the starting pressure. From the valve the oil is returned to the mixer where it is again mixed with the refrigerant to repeat the process.

From the separator, the refrigerant vapor is passed to a condenser so as to liquefy it. The liquid is passed to an expansion valve, throttling the liquid refrigerant to cool the refrigerant. The cooled, throttled refrigerant can be liquid, vapor or a combination depending on the operator's choice. The cooled refrigerant is passed through the evaporator whereby the cooling ability of the refrigerant is utilized to cool a material (water or air) that is in a heat-exchanging relationship with the evaporator. The refrigerant is then returned from the evaporator to the mixer where it is again mixed with the oil to repeat the process again.

The input parameters for the single effect absorption cycle are:
1) Evaporator Temperature—Refrigerant Side: 2° C.
2) Condenser Temperature—Refrigerant Side: 40° C.
3) 3000 kJ/hr supplied to boiler
4) Saturated liquid leaving the absorber
5) Superheat leaving the evaporator: 3° C.
6) The composition of stream entering the separator is 90 wt % oil and 10 wt % refrigerant.
   With these parameters, and using waste heat and/or solar-derived and/or geothermal-derived heat, the calculated coefficient of performance (“COP”) using 1234ze(E) and the Ford motor craft oil is 4.56.

### Example 4

The data from Example 2 was used to develop a double effect absorption cycle. A Ford Motorcraft polypropylene glycol dimethyl ether-based oil is mixed with a liquid 1234ze(E) refrigerant in a closed mixer. The mixture is passed to a first absorber where the gaseous 1234ze(E) dissolves into the oil. The mixture is then passed to first pump that pressurizes the mixture and passes the mixture to a first heat exchanger/boiler. In the boiler, heat is exchanged with the mixture. The source of that heat can be thermal heat from solar collector external to the heat exchanger. The temperature of the mixture is raised. The heated mixture is removed from the heat exchanger and introduced to a second mixer where it is mixed with oil. The mixture from the second mixer is then introduced to a second absorber to ensure that all of the 1234ze(E) is dissolved in the oil. From the second absorber, the mixture is drawn to a second pump that pumps the mixture to a second boiler where the temperature of the mixture is raised to a temperature where the 1234ze(E) refrigerant can separate from the oil. A source of heat to the boiler, again, is provided to accomplish this, which source can be a thermal heat source derived from a solar collector.

The mixture is taken from the second boiler to a separator whereby the refrigerant separates substantially in a vapor state from the oil that remains substantially in a liquid state. The oil is then returned to a tee where it is split sending a portion of the oil through a second oil valve and to the second mixer and the remaining portion of the oil to a first oil valve where the pressure is decreased to match the starting pressure. The oil then passes to the first mixer where it is again mixed with the refrigerant to repeat the process.

From the separator, the refrigerant vapor is passed to a condenser so as to liquefy it. The liquid is passed through an expansion valve, throttling the liquid refrigerant to cool the refrigerant. The cooled, throttled refrigerant can be liquid, vapor or a combination depending on the operator's choice. The cooled refrigerant is passed through an evaporator whereby the cooling ability of the refrigerant is utilized to cool a material (water or air) external of evaporator. The refrigerant is then returned from the evaporator to the first mixer where it is again mixed with the oil to repeat the process again.

The input parameters for the double effect absorption cycle are:
1) Evaporator Temperature—Refrigerant Side: 2° C.
2) Condenser Temperature—Refrigerant Side: 40° C.
3) Pressure exiting the pump is exp(ln(\sqrt{Pₑᵥₐₚ·P_{cond}}))
4) 1500 kJ/hr supplied to the generator boiler
5) Saturated liquid leaving both absorbers
6) Superheat leaving the evaporator: 3° C.
7) Tee splits the flow 30% of the stream to the intermediate stage absorber and 70% to the low stage absorber.
8) The overall composition of the stream entering the separator is 90 wt % oil and 10 wt % refrigerant.
   With these parameters, and using waste heat and/or solar-derived and/or geothermal-derived heat, the calculated COP using 1234ze(E) and Ford motor craft oil is 5.04.

### Example 5

The solubility of trans-1,3,3,3-tetrafluoropropene (1234ze(E)) in POE oil—Ultra 22 CC—was measured by means of a micro-balance. The solubility that was measured and the data correlated using the NRTL activity coefficient model (Renon H., Prausnitz J. M., “Local Compositions in Thermodynamic Excess Functions for Liquid Mixtures,” AIChE J., 14(1), S.135-144, 1968)), the results of which are shown in FIG. 2. From this data it is seen that the POE oil has nearly negligible vapor pressure and that the NRTL activity coefficient model (which, again, was derived from the data obtained) can accurately represent the data.

### Example 6

The solubility data in Example 5 was used to develop a model single effect absorption cycle. More specifically, in the model system, the POE oil is mixed with a liquid 1234ze(E) refrigerant in a closed mixer (which can be a simple “T” joint connecting two or more lines). The mixture is passed to an absorber where the gaseous 1234ze(E) dissolves into the oil. The liquid mixture is passed to a pump that pressurizes the mixture and passes the mixture through to a heat exchanger/boiler. In the boiler, heat is exchanged with the mixture. The source of that heat can be thermal heat from a solar collector external to the heat exchanger. The temperature of the mixture is raised to a temperature where the 1234ze(E) refrigerant can separate from the oil. The heated mixture is then removed from the heat exchanger and introduced to a separator whereby the refrigerant separates substantially in a vapor state from the oil that remains substantially in a liquid state. The oil is then returned through an oil valve where its pressure is decreased to match the starting pressure. From the valve the oil is returned to the mixer where it is again mixed with the refrigerant to repeat the process.

From the separator, the refrigerant vapor is passed to a condenser so as to liquefy it. The liquid is passed through an expansion valve, throttling the liquid refrigerant to cool the refrigerant. The cooled, throttled refrigerant can be liquid, vapor or a combination depending on the operator's choice. The cooled refrigerant is passed through an evaporator whereby the cooling ability of the refrigerant is utilized to cool a material (water or air) that is in a heat-exchanging relationship with the evaporator. The refrigerant is then returned from the evaporator to the mixer where it is again mixed with the oil to repeat the process again.

The input parameters for the single effect absorption cycle were:
1) Evaporator Temperature—Refrigerant Side: 2° C.
2) Condenser Temperature—Refrigerant Side: 40° C.
3) 3000 kJ/hr supplied to generator boiler
4) Saturated liquid leaving both absorbers
5) Superheat leaving the evaporator: 3° C.
6) The composition of stream entering the separator is 90 wt % oil and 10 wt % refrigerant.

With these parameters, and using waste heat and/or solar-derived and/or geothermal-derived heat, the calculated coefficient of performance (“COP”) using 1234ze(E) and the POE oil was 4.96.

### Example 7

The solubility data in Example 5 was used to develop a model double effect absorption cycle. More specifically, in the model system mineral oil is mixed with a liquid 1234ze(E) refrigerant in a closed mixer. The mixture is passed to a first absorber where the gaseous 1234ze(E) dissolves into the oil. The mixture is then passed to a first pump that pressurizes the mixture and passes the mixture through to a first heat exchanger/boiler. In the boiler, heat is exchanged with the mixture. The source of that heat can be thermal heat from a solar collector external to the heat exchanger. The temperature of the mixture is raised. The heated mixture is removed from the heat exchanger and introduced to a second mixer where it is mixed with oil. The mixture from the second mixer is introduced to a second absorber to ensure that all of the 1234ze(E) is dissolved in the oil. From the second absorber, the mixture is drawn to a second pump that pumps the mixture to a second boiler where the temperature of the mixture is raised to a temperature where the 1234ze(E) refrigerant can separate from the oil. A source of heat to the second boiler is provided to accomplish this, which can be thermal heat from a solar collector.

The mixture is taken from the second boiler to a separator whereby the refrigerant separates substantially in a vapor state from the oil that remains substantially in a liquid state. The oil is then returned to a tee where it is split. A portion is sent through a second oil valve and to the second mixer. The remaining portion is sent through a first oil valve where the pressure is decreased to match the starting pressure. The oil then passes to the first mixer where it is again mixed with the refrigerant to repeat the process.

From the separator, the refrigerant vapor is passed to a condenser so as to liquefy it. The liquid is passed through an expansion valve, throttling the liquid refrigerant to cool the refrigerant. The cooled, throttled refrigerant can be liquid, vapor or a combination depending on the operator's choice. The cooled refrigerant is passed through an evaporator whereby the cooling ability of the refrigerant is utilized to cool a material (water or air) external of the evaporator. The refrigerant is then returned from the evaporator to the first mixer where it is again mixed with the oil to repeat the process again.

The parameters for this double effect absorption cycle were:
1) Evaporator Temperature—Refrigerant Side: 2° C.
2) Condenser Temperature—Refrigerant Side: 40° C.
3) Pressure exiting the pump is exp(ln(\sqrt{Pₑᵥₐₚ·P_{cond}}))
4) 1500 kJ/hr supplied to the generator boiler
5) Saturated liquid leaving both absorbers
6) Superheat leaving the evaporator: 3° C.
7) Tee splits the flow 30% of the stream to the intermediate stage absorber and 70% to the low stage absorber.
8) The overall composition of the stream entering the separator is 90 wt % oil and 10 wt % refrigerant.

With these parameters the calculated COP using 1234ze(E) and POE was 5.35.

### Example 8

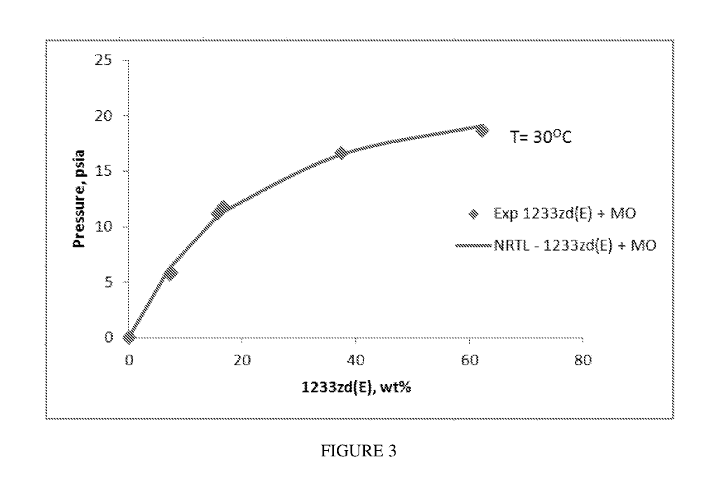

The solubility of trans-1-chloro-3,3,3-trifluoropropene (1233zd(E)) in mineral oil—C-3 refrigeration oil—was measured by means of a micro-balance. The solubility that was measured and the data correlated using the NRTL activity coefficient model (Renon H., Prausnitz J. M., “Local Compositions in Thermodynamic Excess Functions for Liquid Mixtures,” AIChE J., 14(1), S.135-144, 1968)), which is shown in FIG. 3. From this data was seen that the mineral oil has nearly negligible vapor pressure and that the NRTL activity coefficient model (which, again, was derived from the data obtained) can accurately represent the data.

### Example 9

The solubility data of Example 8 was used to develop a model single effect absorption cycle. More specifically, in the model system, mineral oil is mixed with a liquid 1233zd(E) refrigerant in a closed mixer (which can be a simple “T” joint connecting two or more lines). The mixture in passes to an absorber where the gaseous 1233zd(E) dissolves into the oil. The liquid mixture is passed through to a pump that pressurizes the mixture and passes the mixture to a heat exchanger/boiler. In the boiler, heat is exchanged with the mixture. The source of that heat can be thermal heat from a solar collector external to the heat exchanger. The temperature of the mixture is raised to a temperature where the 1233zd(E) refrigerant can separate from the oil. The heated mixture is removed from the heat exchanger and introduced to a separator whereby the refrigerant separates substantially in a vapor state from the oil that remains substantially in a liquid state. The oil is then returned to an oil valve where its pressure is decreased to match the starting pressure. From the valve, the oil is returned to the mixer where it is again mixed with the refrigerant to repeat the process.

From the separator, the refrigerant vapor is passed to a condenser so as to liquefy it. The liquid is passed through an expansion valve, throttling the liquid refrigerant to cool the refrigerant. The cooled, throttled refrigerant can be liquid, vapor or a combination depending on the operator's choice. The cooled refrigerant is passed through an evaporator whereby the cooling ability of the refrigerant is utilized to cool a material (water or air) that is in a heat-exchanging relationship with the evaporator. The refrigerant is then returned from the evaporator to the mixer where it is again mixed with the oil to repeat the process again.

The input parameters for the single effect absorption cycle were:
1) Evaporator Temperature—Refrigerant Side: 2° C.
2) Condenser Temperature—Refrigerant Side: 40° C.
3) 3000 kJ/hr supplied to generator boiler
4) Saturated liquid leaving both absorbers
5) Superheat leaving the evaporator: 3° C.
6) The composition of stream entering the separator is 90 wt % oil and 10 wt % refrigerant.

With these parameters, and assuming that waste heat is utilized, the calculated coefficient of performance (“COP”) using 1233zd(E) and the mineral oil was 21.61.

### Example 10

The solubility data from Example 8 was used to develop a model double effect absorption cycle. More specifically, in the model system mineral oil is mixed with a liquid 1233zd(E) refrigerant in a closed mixer. The mixture is passed to a first absorber where the gaseous 1233zd(E) dissolves into the oil. The mixture is then passed to a first pump that pressurizes the mixture and passes it to a first heat exchanger/boiler. In the boiler, heat is exchanged with the mixture. The source of that heat can be thermal heat from a solar collector external to the heat exchanger. The temperature of the mixture is raised. The heated mixture is then removed from the heat exchanger and introduced to a second mixer where it is mixed with oil. The mixture from the second mixer is then introduced to a second absorber to ensure that all of the 1233zd(E) is dissolved in the oil. From the second absorber, the mixture is drawn to a second pump that pumps the mixture to a second boiler where the temperature of the mixture is raised to a temperature where the 1233zd(E) refrigerant can separate from the oil. A source of heat to boiler is provided to accomplish this, which source can be of the type described above (i.e. a solar collector).

The mixture is taken from the second boiler to a separator whereby the refrigerant separates substantially in a vapor state from the oil that remains substantially in a liquid state. The oil is then returned to a tee where it is split. A portion of the oil is sent to a second oil valve and to the second mixer. The remaining portion of the oil is sent to a first oil valve where the pressure is decreased to match the starting pressure. The oil then passes to the first mixer where it is again mixed with the refrigerant to repeat the process.

From the separator, the refrigerant vapor is passed to a condenser so as to liquefy it. The liquid is then passed through an expansion valve, throttling the liquid refrigerant to cool the refrigerant. The cooled, throttled refrigerant can be liquid, vapor or a combination depending on the operator's choice. The cooled refrigerant is then passed through an evaporator whereby the cooling ability of the refrigerant is utilized to cool a material (water or air) external of the evaporator. The refrigerant is then returned from the evaporator to the first mixer where it is again mixed with the oil to repeat the process.

The input parameters for this double effect absorption cycle were:
1) Evaporator Temperature—Refrigerant Side: 2° C.
2) Condenser Temperature—Refrigerant Side: 40° C.
3) Pressure exiting the pump is exp(ln(\sqrt{Pₑᵥₐₚ·P_{cond}}))
4) 1500 kJ/hr supplied to the generator boiler
5) Saturated liquid leaving both absorbers
6) Superheat leaving the evaporator: 3° C.
7) Tee splits the flow 30% to stream the intermediate stage absorber and 70% to the low stage absorber.
8) The overall composition of the stream entering the separator is 90 wt % oil and 10 wt % refrigerant.

With these parameters, and using waste heat and/or solar-derived and/or geothermal-derived heat, the calculated COP using 1233zd(E) and mineral oil was 25.69.

### Example 11

It has been identified that the solubility of refrigerant in the absorber is important to the overall performance of many important embodiments of the refrigeration cycle of the present invention. More specifically, higher concentrations of absorbed refrigerant tend to increase cycle COP by decreasing the boiler/generator load, both in reducing the mixture's boiling point as well as reducing the amount of heat needed to reach said boiling point. Additionally, pressure is an important parameter in determining both the absorber solubility and the evaporator temperature, and accordingly higher solubilities tend to reduce the required low side pressure allowing for more flexibility in the evaporator operating conditions. Solubility data was determined for both HFO-1234ze(E) and HFO-1234yf in different grades of POE oil at temperatures and pressures that are important for many absorbtion refrigeration cycles in accordance with the present, and this data are reported below.

Solubility of Refrigerants in the Absorber

| | | | |
|---|---|---|---|
| POE Oil Grade | 1234ze(E) Solubility | 1234yf Solubility | Ratio |

30° C. Absorber Temperature

| | | | |
|---|---|---|---|
| ISO 10 | 27 wt % | 22 wt % | 1.23 |
| ISO 32 | 21 wt % | 16 wt % | 1.31 |
| ISO 68 | 19 wt % | 16 wt % | 1.19 |

40° C. Absorber Temperature

| | | | |
|---|---|---|---|
| ISO 10 | 19 wt % | 15 wt % | 1.27 |
| ISO 32 | 14 wt % | 11 wt % | 1.27 |
| ISO 68 | 13 wt % | 11 wt % | 1.18 |

50° C. Absorber Temperature

| | | | |
|---|---|---|---|
| ISO 10 | 14 wt % | 11 wt % | 1.27 |
| ISO 32 | 10 wt % | 8 wt % | 1.25 |
| ISO 68 | 9 wt % | 8 wt % | 1.13 |

Although both refrigerants appreciably dissolve in POE oil, 1234ze(E) was observed to have a distinct solubility advantage over 1234yf for temperatures in the range of from about 30 C to about 50 C. On average, POE oil will absorb 23% more 1234ze(E) than 1234yf for temperatures in the range of particular interest in absorption refrigeration cycle operations. Furthermore, it was discovered that as the both viscosity of the oil (lower ISO grades) and the absorber temperature decreases, the solubility of refrigerant increases. As such, a non-limiting preferred embodiment for the absorption cycle would include 1234ze(E) and POE oil, more preferably 1234ze(E) with ISO 10 POE oil at absorber temperatures less than 50° C.

### Example 12

An absorption refrigeration system as disclosed in FIG. 4 is used. POE oil of ISO 10 is mixed with a liquid 1234ze(E) refrigerant in a closed mixer and utilized according to the conditions and operating parameters described in Example 3. Effective absorption refrigeration is achieved.

### Example 13

An absorption refrigeration system as disclosed in FIG. 4 is used. POE oil of ISO 32 is mixed with a liquid 1234ze(E) refrigerant in a closed mixer and utilized according to the conditions and operating parameters described in Example 3. Effective absorption refrigeration is achieved.

### Example 14

An absorption refrigeration system as disclosed in FIG. 4 is used. POE oil of ISO 68 is mixed with a liquid 1234ze(E) refrigerant in a closed mixer and utilized according to the conditions and operating parameters described in Example 3. Effective absorption refrigeration is achieved.

### Example 15

An absorption refrigeration system as disclosed in FIG. 4 is used. POE oil of ISO 10 is mixed with a liquid 1234yf refrigerant in a closed mixer and utilized according to the conditions and operating parameters described in Example 3. Effective absorption refrigeration is achieved.

### Example 16

An absorption refrigeration system as disclosed in FIG. 4 is used. POE oil of ISO 32 is mixed with a liquid 1234yf refrigerant in a closed mixer and utilized according to the conditions and operating parameters described in Example 3. Effective absorption refrigeration is achieved.

### Example 17

An absorption refrigeration system as disclosed in FIG. 4 is used. POE oil of ISO 68 is mixed with a liquid 1234yf refrigerant in a closed mixer and utilized according to the conditions and operating parameters described in Example 3. Effective absorption refrigeration is achieved.

### Example 18

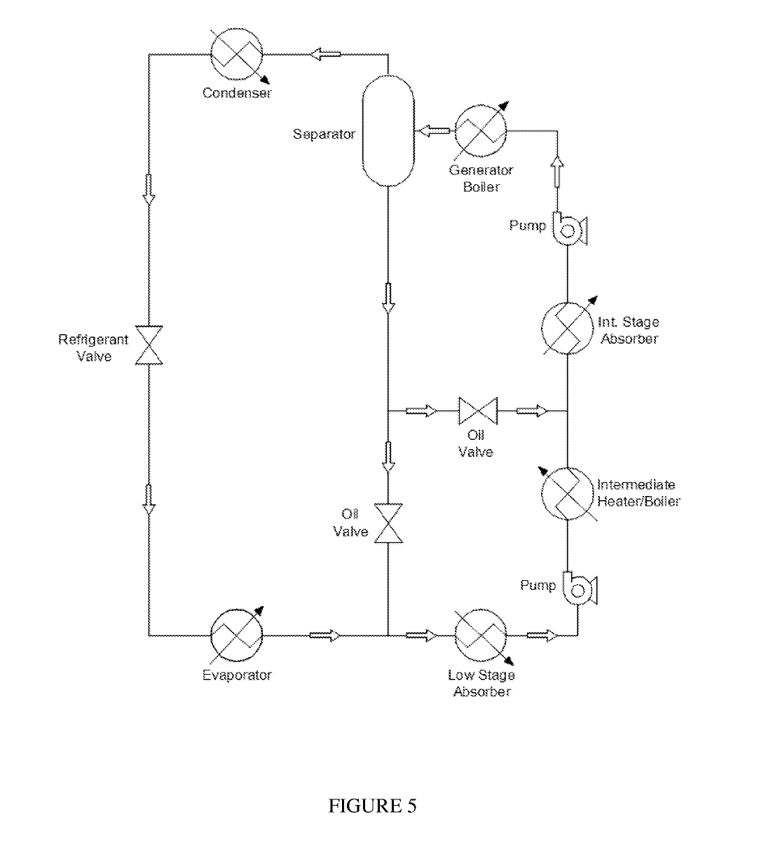

A mulit-stage absorption refrigeration system as disclosed in FIG. 5 is used. POE oil of ISO 10 is mixed with a liquid 1234ze(E) refrigerant in a closed mixer and utilized according to the conditions and operating parameters described in Example 6. Effective absorption refrigeration is achieved.

### Example 19

A mulit-stage absorption refrigeration system as disclosed in FIG. 5 is used. POE oil of ISO 32 is mixed with a liquid 1234ze(E) refrigerant in a closed mixer and utilized according to the conditions and operating parameters described in Example 6. Effective absorption refrigeration is achieved.

### Example 20

A mulit-stage absorption refrigeration system as disclosed in FIG. 5 is used. POE oil of ISO 68 is mixed with a liquid 1234ze(E) refrigerant in a closed mixer and utilized according to the conditions and operating parameters described in Example 6. Effective absorption refrigeration is achieved.

### Example 21

A mulit-stage absorption refrigeration system as disclosed in FIG. 5 is used. POE oil of ISO 10 is mixed with a liquid 1234yf refrigerant in a closed mixer and utilized according to the conditions and operating parameters described in Example 6. Effective absorption refrigeration is achieved.

### Example 22

A mulit-stage absorption refrigeration system as disclosed in FIG. 5 is used. POE oil of ISO 32 is mixed with a liquid 1234yf refrigerant in a closed mixer and utilized according to the conditions and operating parameters described in Example 6. Effective absorption refrigeration is achieved.

### Example 23

A absorption refrigeration system as disclosed in FIG. 5 is used. POE oil of ISO 68 is mixed with a liquid 1234yf refrigerant in a closed mixer and utilized according to the conditions and operating parameters described in Example 2. Effective absorption refrigeration is achieved.

### Example 24

Solubility data was determined for transHCFO-1233zd in three refrigeration lubricants at temperatures and pressures that are important for many absorption refrigeration cycles in accordance with the present invention, and these data are reported below.

Solubility of 1233zd in the Absorber

| | |
|---|---|
| Refrigeration Oil | 1233zd Solubility |

30° C. Absorber Temperature

| | |
|---|---|
| Alkylbenzene | 20 wt % |
| Silicone | 19 wt % |
| Mineral | 15 wt % |

40° C. Absorber Temperature

| | |
|---|---|
| Alkylbenzene | 13 wt % |
| Silicone | 11 wt % |
| Mineral | 9 wt % |

50° C. Absorber Temperature

| | |
|---|---|
| Alkylbenzene | 8 wt % |
| Silicone | 8 wt % |
| Mineral | 7 wt % |

It was observed that 1233zd appreciably dissolves in each of alkylbenzene, silicone, and mineral oil, with alkylbenzene oil having the solubility advantage especially at temperatures closer to 30° C. As such, non-limiting preferred embodiments for the absorption cycle would include 1233zd and in any of alkylbenzene, silicone, or mineral oil, more preferably 1233zd with alkylbenzene oil at absorber temperatures less than 50° C.

### Example 25

An absorption refrigeration system as disclosed in FIG. 4 is used. Alkylbenzene oil is mixed with a liquid 1233zd(E) refrigerant in a closed mixer and utilized according to the conditions and operating parameters described in Example 3. Effective absorption refrigeration is achieved.

### Example 26

An absorption refrigeration system as disclosed in FIG. 4 is used. Silicon oil is mixed with a liquid 1233zd(E) refrigerant in a closed mixer and utilized according to the conditions and operating parameters described in Example 3. Effective absorption refrigeration is achieved.

### Example 27

A multi-stage absorption refrigeration system as disclosed in FIG. 5 is used. Alkylbenzene oil is mixed with a liquid 1233zd(E) refrigerant in a closed mixer and utilized according to the conditions and operating parameters described in Example 6. Effective absorption refrigeration is achieved.

### Example 28

An absorption refrigeration system as disclosed in FIG. 5 is used. Silicon oil is mixed with a liquid 1233zd(E) refrigerant in a closed mixer and utilized according to the conditions and operating parameters described in Example 6. Effective absorption refrigeration is achieved.

What is claimed is:

1. A method for providing refrigeration, comprising:
a. evaporating a first liquid-phase refrigerant stream comprising a refrigerant selected from the group consisting of one or more hydrofluoroolefins, one or more hydrochlorofluoroolefins, and blends thereof, to produce a low-pressure vapor-phase refrigerant stream, wherein said evaporating transfers heat from a system to be cooled;
b. contacting said low-pressure vapor-phase refrigerant stream with a first liquid-phase solvent stream comprising a solvent selected from the group consisting of a polyalkyene glycol oil, a poly alpha olefin oil, a mineral oil, a polyolester oil, and combinations thereof under conditions effective to dissolve substantially all of the refrigerant of the vapor-phase refrigerant stream into the solvent of the first liquid-phase solvent stream to produce a refrigerant-solvent solution stream;
c. increasing the pressure and temperature of the refrigerant-solvent solution stream by transfer of heat from a solar collector to said solution.
d. thermodynamically separating said refrigerant-solvent solution stream into a high-pressure vapor-phase refrigerant stream and a second liquid-phase solvent stream;
e. recycling said second liquid-phase solvent stream to step (b) to produce said first liquid-phase solvent stream;
f. condensing said high-pressure vapor-phase refrigerant stream to produce a second liquid phase refrigerant stream; and
g. recycling said second liquid-phase refrigerant stream to step (a) to produce said first liquid-phase refrigerant stream.

2. The method of claim 1 wherein said refrigerant comprises at least one compound having the formula C_{w}HₓF_{y}Cl_{z} where w is an integer from 3 to 5, x is an integer from 1 to 3, z is an integer from 0 to 1, and y=2w−x−z.

3. The method of claim 2 wherein said refrigerant is selected from one or more of 1,1,1,2-tetrafluoropropene, trans-1,3,3,3-tertafluoropropene, cis-1,3,3,3-tertafluoropropene, trans-1-chloro-3,3,3-trifluoropropene, cis-1-chloro-3,3,3-trifluoropropene and 3,3,3-trifluoropropene.

4. The method of claim 1 wherein said solvent is selected from the group consisting of poly-ethylene glycol oils, polyol ester oils, polypropylene glycol dimethyl ether-based and mineral oil.

5. The method of claim 1 wherein the solar power source is a concentrated system.

6. The method of claim 1 wherein the solar power source is a non-concentrated system.

7. The method of claim 1 wherein said refrigerant comprises from 99% to 100% by weight of trans-1,3,3,3-tertafluoropropene and said solvent comprises from 99% to 100% by weight of polyol ester oil.

8. The method of claim 1 wherein said refrigerant comprises from 99% to 100% by weight of trans-1-chloro-3,3,3-trifluoropropene and said solvent comprises from 99% to 100% by weight of mineral oil.

9. The method of claim 1 wherein said refrigerant comprises from 99% to 100% by weight of trans-1-chloro-3,3,3-trifluoropropene and said solvent comprises from 99% to 100% by weight of alkyl benzene.

10. The method of claim 1 wherein said refrigerant comprises from 99% to 100% by weight of 2,3,3,3-tertafluoropropene and said solvent comprises from 99% to 100% by weight of polyol alkylene glycol oil.

11. An absorption refrigeration system comprising:
a. a refrigerant selected from the group consisting of one or more hydrofluoroolefins, one or more hydrochlorofluoroolefins, and blends thereof;
b. a solvent selected from the group consisting of a polyalkyene glycol oil, a poly alpha olefin oil, a mineral oil, a polyolester oil, and combinations thereof;
c. an evaporator suitable for evaporating said refrigerant;
d. a mixer suitable for mixing said refrigerant with said solvent, wherein said mixer is fluidly connected to said evaporator;
e. an absorber suitable for dissolving at least a portion of said refrigerant into said solvent to produce a solution, wherein said absorber is fluidly connect to said mixer;
f. a pump fluidly connected to said absorber;
g. a heat exchanger fluidly connected to said pump, wherein the heat exchanger is powered by a solar collector;
h. a separator suitable for thermodynamically separating said solution into a vapor refrigerant component and a liquid solvent component, wherein said separator is fluidly connected to said heat exchanger;
i. an oil return line fluidly connected to said separator and said mixer, and
j. a condenser suitable for condensing said vapor refrigerant component, wherein said condenser is fluidly connected to said separator and said evaporator.

12. The system of claim 11 wherein said refrigerant comprises at least one compound having the formula C_{w}HₓF_{y}Cl_{z} where w is an integer from 3 to 5, x is an integer from 0 to 3, z is an integer from 0 to 1, and y=2w−x−z, provided that x and z are not both zero.

13. The system of claim 12 wherein said refrigerant is selected from one or more of 1,1,1,2-tetrafluoropropene, trans-1,3,3,3-tertafluoropropene, cis-1,3,3,3-tertafluoropropene, trans-1-chloro-3,3,3-trifluoropropene, cis-1-chloro-3,3,3-trifluoropropene and 3,3,3-trifluoropropene.

14. The system of claim 11 wherein said solvent is selected from the group consisting of poly-ethylene glycol oils, polyol ester oils, polypropylene glycol dimethyl ether-based and mineral oil.

15. The system of claim 11 wherein said separator is a distillation column or a flashing separator.

16. The method of claim 11 wherein said refrigerant comprises from 99% to 100% by weight of trans-1,3,3,3-tertafluoropropene and said solvent comprises from 99% to 100% by weight of polyol ester oil.

17. The method of claim 11 wherein said refrigerant comprises from 99% to 100% by weight of trans-1-chloro-3,3,3-trifluoropropene and said solvent comprises from 99% to 100% by weight of mineral oil.

18. The method of claim 11 wherein said refrigerant comprises from 99% to 100% by weight of trans-1-chloro-3,3,3-trifluoropropene and said solvent comprises from 99% to 100% by weight of alkyl benzene.

19. The method of claim 11 wherein said refrigerant comprises from 99% to 100% by weight of 2,3,3,3-tertafluoropropene and said solvent comprises from 99% to 100% by weight of polyol alkylene glycol oil.
